(19) United States
(12) Patent Application Publication
(10) Pub. No.: US 2005/0015602 A1
(43) Pub. Date: Jan. 20, 2005

(54) Method and apparatus for passing data securely between parties

(76) Inventor: Robert Thomas Owen Rees, Newport (GB)

Correspondence Address: HEWLETT-PACKARD COMPANY;Intellectual Property Administration, P.O. Box 272400, Fort Collins, CO, 80527-2400, US

(21) Appl. No.: 10/816,679

(22) Filed: Apr. 2, 2004

(30) Foreign Application Priority Data
Apr. 28, 2003 (GB) 0309560.1

(51) Int. Cl. H04K 1/00

(52) U.S. Cl. 713/182

(57) ABSTRACT

A method of passing data securely from an originator to a recipient comprises the steps of: the originator selecting a condition that the recipient must meet for receipt of the data; the originator selecting a trusted party; the originator selecting a first key without reference to the condition; the originator encrypting the data using the first key; the originator making the condition, and the encrypted data available to the recipient; the recipient providing the trusted party with evidence that it meets the condition; the trusted party satisfying itself that the recipient does meet the condition and providing the first key to the recipient, and the recipient decrypting the data using the first key.

### FIELD OF THE INVENTION

The present invention relates to a method and apparatus for passing data securely between parties and in particular, although not exclusively, for use when the originating party does not know the identity of the receiving party, or where the receiving party is not yet in a position to receive the data.

### BACKGROUND OF THE INVENTION

For data to be passed between parties securely it is common for it to be encrypted. It is usual, at the time an originating party encrypts data, for the receiving and therefore decrypting party to be known, and hence for the two parties to be able to liaise appropriately concerning the symmetric key or asymmetric key pair to be used for encryption and decryption. However there are circumstances where the encrypting party will not know the identity of the decrypting party, indeed they might not yet exist, or the decrypting party may simply not yet be in a position to receive and decrypt the data (e.g. they do not yet have their computer system functioning or are not connected to the Internet). In such circumstances it may be necessary for the encrypting party to set a condition, comprising one or more criteria, which the decrypting party must meet to be able to receive and decrypt the data.

In the prior art there are some circumstances where messages are encrypted for a known recipient but cannot be decrypted until a predetermined condition, comprising one or more criteria, is met. For example in sealed bid auctions the bids may be submitted at any time up to a specified deadline but may only be decrypted by the receiving party after a certain date and time on or after that deadline. Thus in this case the condition is that the relevant date and time have passed. In addition, in the purchase of music via the Internet the music might be sent to the purchaser encrypted, but the purchaser might only be able to decrypt that data after the seller has received the necessary payment. In this case the condition is the payment being received by the seller.

It is desirable to provide a method and apparatus for passing data securely between parties which can be used if the recipient is as yet unknown or not yet able to receive the data.

### SUMMARY OF THE INVENTION

According to a first aspect of the present invention there is provided a method of passing data securely from an originator to a recipient comprising the steps of: the originator selecting a condition that the recipient must meet for receipt of the data; the originator selecting a trusted party; the originator selecting a first key without reference to the condition; the originator encrypting the data using the first key; the originator making the condition, and the encrypted data available to the recipient; the recipient providing the trusted party with evidence that it meets the condition; the trusted party satisfying itself that the recipient does meet the condition and providing the first key to the recipient, and the recipient decrypting the data using the first key.

The trusted party may have an asymmetric key pair comprising a public key and a private key, of which the public key is known, and the method may then include the additional steps of: the originator encrypting the condition and the first key using the public key of the trusted party; the originator making the encrypted condition and first key available to the recipient; the recipient forwarding the encrypted condition and first key to the trusted party, with the proof that it meets the condition, and the trusted party decrypting the condition and first key using its private key and satisfying itself that the recipient meets the condition.

The recipient may also have an asymmetric key pair comprising a private key and a public key and the method may also include the additional steps of: the recipient providing its public key to the trusted party; the trusted party encrypting the first key with the recipient's public key and then transmitting it to the recipient, and the recipient decrypting the first key using it's private key before using it to decrypt the data.

The first key may be an asymmetric key pair, of which the encrypting first key is used to encrypt the data and the decrypting first key is encrypted with the condition using the public key of the trusted party.

The selection of the first key may comprise the originator requesting it from the trusted party which generates an asymmetric key pair and provides the encrypting key of the asymmetric key pair to the originator to act as an encrypting first key; and the method may include the additional steps of: the originator providing the condition to the trusted party; the trusted party storing the condition and the asymmetric key pair; the recipient providing the trusted party with evidence that it meets the condition; the trusted party retrieving the condition and asymmetric key pair from store, and satisfying itself that the recipient meets the condition, and the trusted party providing the decrypting key of the asymmetric key pair to the recipient to act as a decrypting first key.

The method may then include the additional steps of: the trusted party encrypting the decrypting first key with the recipient's public key before transmitting it to the recipient, and the recipient decrypting the decrypting first key before using it to decrypt the data.

At the time the originator encrypts the data the recipient may be unknown to them.

The step of the originator making available the condition and the encrypted data may involve publishing or storing it for later collection by the recipient.

In addition the step of the originator making available the condition and the encrypted data may involve saving it onto a physical storage medium for later collection by the recipient.

According to a second aspect of the invention there is provided a method for an originator to make data available securely to a recipient comprising the steps of: the originator selecting a condition that the recipient must meet for receipt of the data; the originator selecting a trusted party; the originator selecting a first key without reference to the condition; the originator encrypting the data using the first key, and the originator making the condition, and the encrypted data available to the recipient.

Conveniently the trusted party may have an asymmetric key pair comprising a public key and a private key, of which the public key is known, and the method may then include the additional steps of: the originator encrypting the condition and the first key using the public key of the trusted party, and the originator making the encrypted condition and first key available to the recipient.

The first key may be an asymmetric key pair, of which the encrypting first key is used to encrypt the data and the decrypting first key is encrypted with the condition using the public key of the trusted party.

The selection of the first key may comprise the originator requesting that the trusted party generates an asymmetric key pair and provides the encrypting key of the asymmetric key pair to the originator to act as an encrypting first key; and the method may then include the additional step of the originator providing the condition to the trusted party.

According to a third aspect of the invention there is provided a method for a recipient to receive data made available securely by an originator, who has selected a trusted party to be involved, comprising the steps of: obtaining a condition for decryption of the data set by the originator and the data encrypted using a first key generated without reference to the condition; providing the trusted party with evidence that it meets the condition; receiving the first key for decryption of the data from the trusted party, and decrypting the data.

The trusted party may have an asymmetric key pair comprising a public key and a private key, of which the public key is known and was used by the originator to encrypt the condition and first key, and the method may then include the additional steps of: obtaining in encrypted form the condition and first key made available by the originator, and forwarding the encrypted condition and first key to the trusted party, with the evidence that it meets the condition.

The recipient may also have an asymmetric key pair comprising a public key and a private key, and the method may then include the additional steps of: providing the trusted party with the its public key; receiving from the trusted party the first key encrypted with the recipients public key, and decrypting the first key using its private key prior to using the first key to decrypt the data.

According to a fourth aspect of the invention there is provided a method for a trusted party to facilitate the passing of data securely from an originator to a recipient, where the originator has selected a condition which the recipient must meet for receipt of the data, and has encrypted the data with a first key generated without reference to the condition, the method comprising the steps of:
receiving from the recipient evidence that they meet the condition;
comparing the evidence against the condition to confirm that the recipient does meet the condition, and if the recipient meets the condition, providing the first key to the recipient.

The trusted party may have an asymmetric key pair comprising a public key and a private key, of which the public key is known, and the method includes the additional steps of:
receiving from the recipient the condition and first key encrypted using the public key of the trusted party;
decrypting the condition and first key using the private key of the trusted party prior to comparing the evidence against the condition to confirm that the recipient does meet the condition.

The method may also further include the additional steps of:
receiving from the recipient its public key;
encrypting the first key with the recipient's public key, and transmitting the encrypted first key to the recipient.

The first key used in the method may be an asymmetric key pair.

The method may include the trusted party being requested by the originator to generate an asymmetric key pair to act as the first key and, once the asymmetric key pair has been generated, the provision of the encrypting first key to the originator, with the method also including the additional steps of:
receiving the condition from the originator;
storing the condition and the asymmetric first key pair;
upon receipt of the evidence from the recipient that they meet the condition, retrieving the condition and asymmetric first key pair from store before comparing the evidence against the condition to confirm that the recipient does meet the condition, and providing to the recipient the decrypting key of the asymmetric first key pair to act as a decrypting first key.

The method may also include the additional step of encrypting the decrypting first key with the recipient's public key before transmitting it to the recipient.

According to a fifth aspect of the invention there is provided a computer system for implementation of the method of any one of the first, second, third or fourth aspects of the invention.

According to a sixth aspect of the invention there is provided a computer system for passing data securely from an originator to a recipient comprising a first computer entity associated with the originator, a second computer entity associated with the recipient and a third computer entity associated with a trusted party, there being communication means between the first computer entity and the second computer entity and between the second computer entity and the third computer entity,
the first computer entity selecting a condition to be met by the recipient before receipt of the data and a first key generated without reference to the condition, and encrypting the data with that first key, and encrypting the condition and the first key using a public key of the trusted party, and making both available to the second computer entity;
the second computer entity being arranged to forward evidence that the recipient meets the condition to the third computer entity;
the third computer entity being arranged to compare the evidence with the condition and if satisfied that the recipient meets the condition to provide the first key to the second computer entity for decryption of the data.

The trusted party may have a public key and: the first computer entity is arranged to encrypt the condition and the first key using the trusted party's public key and make that available to the second computer entity; the second computer entity is arranged to forward the encrypted condition and first key to the third computer entity, and the third computer entity is arranged to decrypt the condition and first key before comparing the evidence with the condition.

The second computer entity may be arranged to provide a public key of the recipient to the third computer entity, and the third computer entity may be arranged to encrypt the first key with the recipients public key before transmitting it to the recipient.

The first computer entity may be arranged to provide the condition to the third computer entity; the third computer entity may be arranged to generate an asymmetric first key pair and to provide the encrypting first key to the first computer entity, and the second computer entity may be arranged to provide the third computer entity with the condition and the evidence.

According to a seventh aspect of the invention there is provided a method of passing data securely from an originator to a recipient comprising the steps of: the originator selecting a condition that the recipient must meet for decryption of the data; the originator selecting a trusted party having a public key; the originator selecting a first key without reference to the condition; the originator encrypting the data using the first key; the originator encrypting the condition and the first key using the public key of the trusted party; the originator making the condition, and the encrypted data and the encrypted condition and first key, available to the recipient; upon receipt by the trusted party of the recipient's public key, the encrypted condition and first key, and evidence that the recipient meets the condition, the trusted party decrypts the condition and first key, satisfies itself that the recipient meets the condition, provides the first key to the recipient, and the recipient decrypts the data using the first key.

According to a eighth aspect of the invention there is provided a method of passing data securely from an originator to a recipient comprising the steps of: the originator selecting a condition that the recipient must meet for decryption of the data; the originator selecting a trusted party; the trusted party generating an asymmetric key pair without reference to the condition and providing the encrypting key of the asymmetric key pair to the originator to act as a first encrypting key; the originator providing the condition to the trusted party; the trusted party storing the condition and the asymmetric key pair; the originator encrypting the data using the first encrypting key; the originator making the condition, and the encrypted data available to the recipient; upon receipt by the trusted party from the recipient of the evidence that the recipient meets the condition the trusted party retrieves the condition and asymmetric key pair from store, satisfies itself that the recipient meets the condition, and provides the decrypting key of the asymmetric key pair to the recipient to act as a first decrypting key, and the recipient decrypting the data using the first decrypting key.

### BRIEF DESCRIPTION OF THE DRAWINGS

Embodiments of the invention will now be described, by way of example only, with reference to the accompanying drawings in which:

FIG. 1 illustrates schematically a computer system according to the invention;

FIG. 2 illustrates a first method according to the invention;

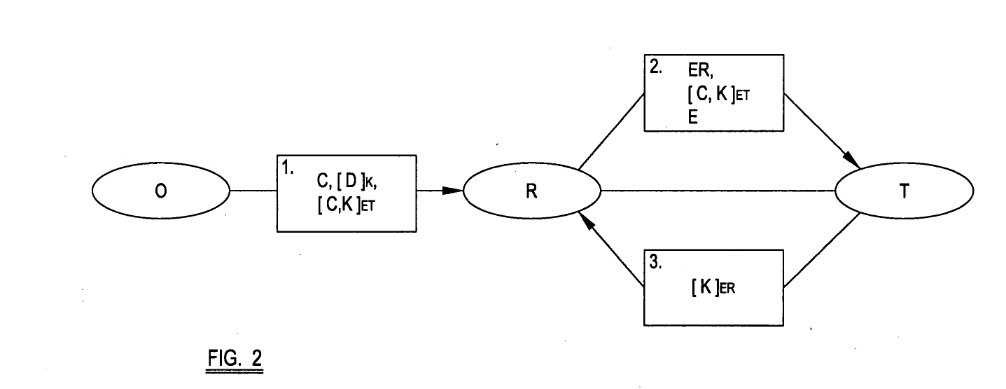

FIG. 3 illustrates a second method according to the invention.

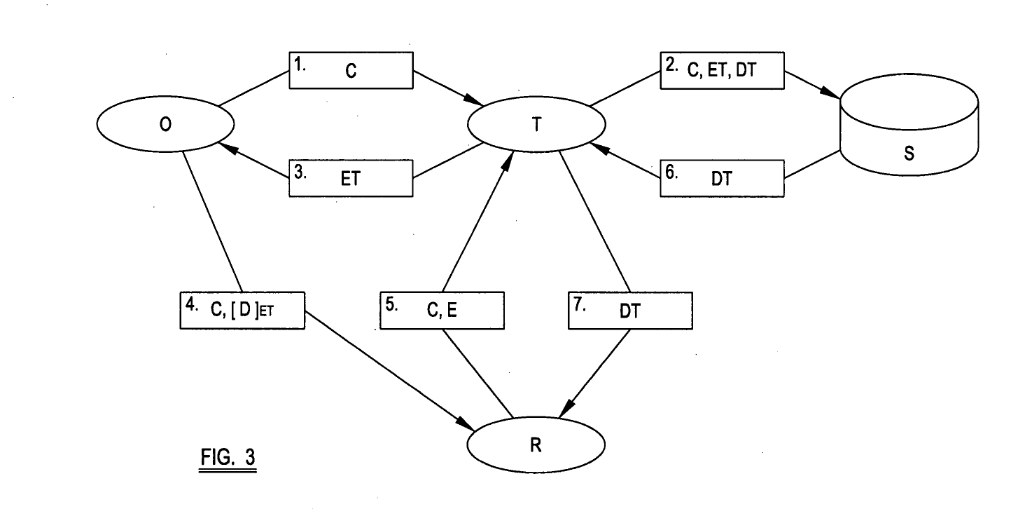

### DETAILED DESCRIPTION OF THE PREFERRED EMBODIMENTS

The present invention addresses the issue of the originator of data wanting to make the data available, in a secure manner, i.e. encrypted, to a recipient who has yet to be identified or is not yet able to receive the data.

There are two basic forms of encryption; symmetric and asymmetric (also known as public key encryption or PKI), both of which may be used in methods according to the invention. In the former the same key is used to encrypt and decrypt the data. In the latter, different keys are used to encrypt and decrypt the data, and these are known as an asymmetric key pair. The asymmetric key pair comprises a public key which is known to everyone and is the key used to encrypt the data, and a private key which is known only to the recipient and which is used to decrypt the data. Clearly this is more secure than symmetric encryption as only the person with the private key can decrypt the data. The public and private keys are related in such a way that it is virtually impossible to deduce the private key from knowledge of the public key. There are various conventions for asymmetric encryption one of which is known as RSA (as it was developed by RSA Data Security, Inc.) and which has become the de-facto industry standard and is built into many common software products.

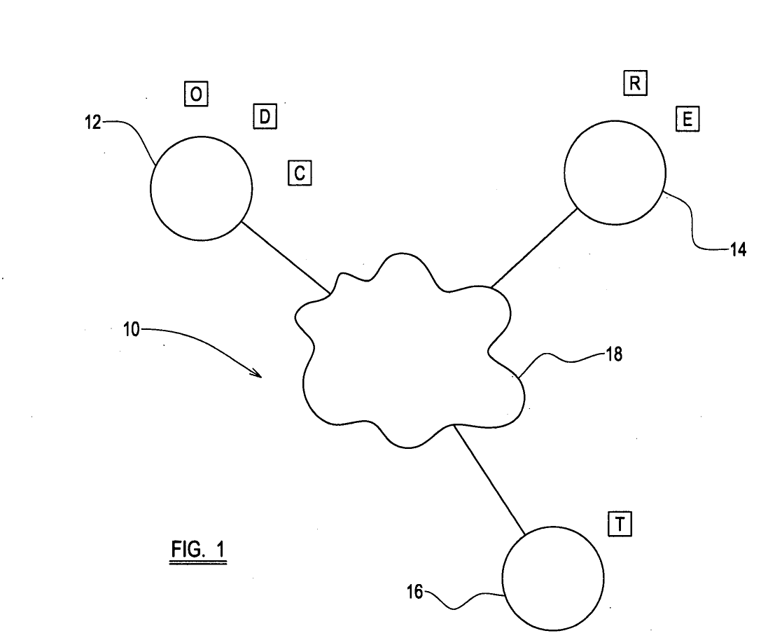

FIG. 1 schematically illustrates a computer system 10, according to a first embodiment of the invention, which includes first, second and third computer entities 12, 14 and 16 respectively coupled via the Internet 18. The computer entities 12, 14 and 16 will typically be configured on three separate computer platforms but could be configured on a single platform.

Although the computer entities 12, 14 and 16 are coupled via the Internet 18 in this example it should be noted that the invention is equally applicable where the transfer of messages between the computer entities is by other means. For examples the computer entities 12, 14 and 16 may all be part of a private computer network such that the messages are still transmitted purely electronically, but they may also have no electronic connections between them with the messages being transferred with the use of physical storage media such as CD ROMs and/or DVDs which are passed from one party to another directly or indirectly via one or more intermediaries.

The first computer entity 12 has associated with it an originator O having data D which they wish to make available to a recipient R who is or will be associated with the second computer entity 14 and who at some time meets a condition C which the originator O has determined, and can prove so with evidence E. The condition C may for examples be that the recipient R has a certain role, or has signed a contract or made a payment. The third computer entity 16 has associated with it a trusted party T.

The originator O wishes to make the data D available to a recipient R who meets the condition C, although they do not know who that recipient R is or cannot send the data D directly to them. The first method according to the invention for doing so is as follows.

The originator O (using symmetric encryption) selects a first key K, using conventional methods such as a random number generator, and encrypts the data D using that first key K. The originator O also selects a trusted party T, which has an asymmetric key pair comprising a public key ET and a private key DT, and a condition C which the recipient R must meet to be able to receive the data D.

The originator O then encrypts the data D using the first key K to form [D]_{K}, and encrypts the condition C and first key K using the public key ET of the trusted party T to form [C, K]_{ET}, and makes the following information I:
(i) the condition C,
(ii) the encrypted data [D]_{K} and
(iii) the encrypted condition and first key [C, K]_{ET}
   available to the recipient R. As the originator O does not know the identity of the recipient R, or cannot for some reason send the data D directly to them, this is achieved by making the information I available on the Internet, or otherwise storing it or publishing it where the recipient can later find it.

The recipient R has an asymmetric key pair comprising a public key ER and a private key DR. When the recipient R has obtained the information I it sends to the trusted party T the following:
(a) its public key ER,
(b) the encrypted condition and first key [C, K]_{ET}, and
(c) the evidence E that it satisfies the condition C.
   The trusted party T decrypts the condition C and first key K (using its private key DT), inspects the evidence E, compares it with the condition C and satisfies itself that the recipient R meets the condition C. When the trusted party T is satisfied that the recipient R meets the condition C it encrypts the first key K using the recipient's public key ER, to form [K]_{ER}, and transmits [K]_{ER} to the recipient R. The recipient R can then decrypt the first key K (using its private key DR) and uses the first key K to decrypt the data D.

Various modifications are possible to this first method according to the invention. As described the first key is a symmetric key, however the originator O may instead select an a symmetric key pair comprising public key EK and private key DK. If that is the case then the originator O uses the encrypting first key EK to encrypt the data D, forming [D]_{EK} and includes the decrypting first key DK in the information encrypted with the trusted party's public key ET to form [C, DK]_{ET}. Otherwise the method is unaltered.

Whatever form the first key takes, symmetric or assymetric, the key is selected in conventional manner using a random number generator or the like, without reference to any known data such as the condition, or the data to be passed to the recipient.

If communications between the trusted party T and the recipient R are secure then the recipient R need not send its public key ER to the trusted party T and the first key K need not be encrypted when sent to the recipient R by the trusted party T. In the event that communications between the various parties O, R and T are not secure then the messages exchanged between them may need further signatures and data to prevent replay and other forms of attack. These additional precautions are well known in the art and have been omitted from the description for clarity.

A second method according to the invention is as follows. The originator O selects a trusted party T and sends the condition C, which must be met by a recipient to be allowed to decrypt the data D, to the trusted party T. The trusted party T generates an asymmetric first key pair ET and DT specifically for this data exchange, e.g. using the well known RSA system, and in any event without reference to the condition C. The trusted party T stores the condition C along with the first key pair ET/DT in a store S (associated with the third computer entity 16). The trusted party T also provides the encrypting first key ET to the originator O. The originator O encrypts the data D using the encrypting first key ET, to form [D]_{ET}, and makes this along with the condition C available to the recipient R. This is achieved in the same way as described above with reference to the first method, i.e. by publishing it or storing it for later collection by the recipient R.

When the recipient R has obtained the encrypted data [D]_{ET} it sends a message to the trusted party T including the condition C and the evidence E that it meets that condition C. The trusted party T inspects the evidence E and satisfies itself that the recipient R does meet the condition C and, if satisfied, retrieves the decrypting first key DT from the store S and forwards it to the recipient R. The recipient R can then use the decrypting first key DT to decrypt the data D.

As for the first method there are possible variations to this second method also. In particular the various messages exchanged between the parties O, R and T may be via secure links or they may need to be further encrypted, signed or both, but as these are known techniques they have been omitted from the above description for the sake of clarity.

Although the exchange of messages between the parties O, T and R has been described as taking place via the Internet the method according to the invention is not limited to such a method of exchange. Any method may be used. For example the information I passed from the originator O to the recipient R in the first method described above, or indeed any other messages exchanged, may be stored on any form of storage media, such as a CD ROM or DVD and physically passed from one party to the other, via one or more intermediaries. In addition the various parties may all be connected to a private network of some kind such that communication between them takes place purely on that network and not via the Internet.

Practical examples of the methods according to the invention in use are as follows.

In the first example, the originator O is a lawyer acting for a company and wishes to send some data D, perhaps to do with a take over of the company, to a group of people, in this case all the directors of the company, whoever they may be at that time (thus there are multiple recipients R). The condition C in this case, that each recipient R has to meet, is that they are a director of the company. So the lawyer sends the encrypted data to the trusted party T as described above, and this is released to the directors R as and when they prove to the trusted party T that they are directors of the company. This means that the lawyer O does not have to check who the directors are at that time, making it easier for them to deal with sending the data to the correct people. If the lawyer concerned is an employee of the company then this whole exchange may take place on the company computer network without any external involvement.

In the second example, the originator O is an individual and the data D is their medical records which they wish to be made available to any person or hospital (the recipient R) who can prove that they meet the condition C that they are treating the originator O. Clearly at the time the originator O arranges for their medical records to be made available in this way they may well have no idea which doctors/hospitals they will in future be treated by, and therefore are unable to identify at that time the recipient(s) R to which the data D should be made available. This method enables the medical records D to be accessible to the relevant recipients R as and when necessary, i.e. as and when they can prove to the trusted party T that they are treating the individual O concerned. Bearing in mind the parties involved, this example is most likely to take place with exchanges occurring between the parties via the Internet.

In the third example, the originator O is someone who has reviewed a confidential document and wishes to provide comments (the data D) to the person (the recipient R) responsible for collating comments and making amendments (the condition C). The originator O may simply know that the recipient R is person working in a particular department, but not know which particular person has been given that role or duty. Thus the originator O makes the data D available using the method of the invention and the trusted party T releases it to the person who proves that they have been given the duty of collating comments and making amendments to the confidential document, i.e. meet the condition C.

1. A method of passing data securely from an originator to a recipient comprising the steps of:
the originator selecting a condition that the recipient must meet for receipt of the data;
the originator selecting a trusted party;
the originator selecting a first key without reference to the condition;
the originator encrypting the data using the first key;
the originator making the condition, and the encrypted data available to the recipient;
the recipient providing the trusted party with evidence that it meets the condition;
the trusted party satisfying itself that the recipient does meet the condition and providing the first key to the recipient, and
the recipient decrypting the data using the first key.

2. A method according to claim 1 wherein the trusted party has an asymmetric key pair comprising a public key and a private key, of which the public key is known, and the method includes the additional steps of:
the originator encrypting the condition and the first key using the public key of the trusted party;
the originator making the encrypted condition and first key available to the recipient;
the recipient forwarding the encrypted condition and first key to the trusted party, with the proof that it meets the condition, and
the trusted party decrypting the condition and first key using its private key and satisfying itself that the recipient meets the condition.

3. A method according to claim 2 wherein the recipient has an asymmetric key pair comprising a private key and a public key and the method includes the additional steps of:
the recipient providing its public key to the trusted party;
the trusted party encrypting the first key with the recipient's public key and then transmitting it to the recipient, and
the recipient decrypting the first key using it's private key before using it to decrypt the data.

4. A method according to claim 2 wherein the first key is an asymmetric key pair, of which the encrypting first key is used to encrypt the data and the decrypting first key is encrypted with the condition using the public key of the trusted party.

5. A method according to claim 1 wherein the selection of the first key comprises the originator requesting it from the trusted party which generates an asymmetric key pair and provides the encrypting key of the asymmetric key pair to the originator to act as an encrypting first key;
and the method includes the additional steps of:
the originator providing the condition to the trusted party;
the trusted party storing the condition and the asymmetric key pair;
the recipient providing the trusted party with evidence that it meets the condition;
the trusted party retrieving the condition and asymmetric key pair from store, and satisfying itself that the recipient meets the condition, and
the trusted party providing the decrypting key of the asymmetric key pair to the recipient to act as a decrypting first key.

6. A method according to claim 5 wherein it includes the additional steps of:
the trusted party encrypting the decrypting first key with the recipient's public key before transmitting it to the recipient, and
the recipient decrypting the decrypting first key before using it to decrypt the data.

7. A method according to claim 1 wherein at the time the originator encrypts the data the recipient is unknown to them.

8. A method according to claim 1 wherein the step of the originator making available the condition and the encrypted data involves publishing or storing it for later collection by the recipient.

9. A method according to claim 8 wherein the step of the originator making available the condition and the encrypted data involves saving it onto a physical storage medium for later collection by the recipient.

10. A method for an originator to make data available securely to a recipient comprising the steps of:
the originator selecting a condition that the recipient must meet for receipt of the data;
the originator selecting a trusted party;
the originator selecting a first key without reference to the condition;
the originator encrypting the data using the first key, and
the originator making the condition, and the encrypted data available to the recipient.

11. A method according to claim 10 wherein the trusted party has an asymmetric key pair comprising a public key and a private key, of which the public key is known, and the method includes the additional steps of:
the originator encrypting the condition and the first key using the public key of the trusted party, and
the originator making the encrypted condition and first key available to the recipient.

12. A method according to claim 11 wherein the first key is an asymmetric key pair, of which the encrypting first key is used to encrypt the data and the decrypting first key is encrypted with the condition using the public key of the trusted party.

13. A method according to claim 10 wherein the selection of the first key comprises the originator requesting that the trusted party generates an asymmetric key pair and provides the encrypting key of the asymmetric key pair to the originator to act as an encrypting first key;
and the method includes the additional step of the originator providing the condition to the trusted party.

14. A method for a recipient to receive data made available securely by an originator, who has selected a trusted party to be involved, comprising the steps of:
obtaining a condition for decryption of the data set by the originator and the data encrypted using a first key generated without reference to the condition and;
providing the trusted party with evidence that it meets the condition;
receiving the first key for decryption of the data from the trusted party, and
decrypting the data.

15. A method according to claim 14 wherein the trusted party has an asymmetric key pair comprising a public key and a private key, of which the public key is known and was used by the originator to encrypt the condition and first key, and the method includes the additional steps of:
obtaining in encrypted form the condition and first key made available by the originator, and
forwarding the encrypted condition and first key to the trusted party, with the evidence that it meets the condition.

16. A method according to claim 15 wherein the recipient has an asymmetric key pair comprising a public key and a private key, and the method includes the additional steps of:
providing the trusted party with the its public key;
receiving from the trusted party the first key encrypted with the recipients public key, and
decrypting the first key using its private key prior to using the first key to decrypt the data.

17. A method for a trusted party to facilitate the passing of data securely from an originator to a recipient, where the originator has selected a condition which the recipient must meet for receipt of the data, and has encrypted the data with a first key generated without reference to the condition, comprising the steps of:
receiving from the recipient evidence that they meet the condition;
comparing the evidence against the condition to confirm that the recipient does meet the condition, and
if the recipient meets the condition, providing the first key to the recipient.

18. A method according to claim 17 wherein the trusted party has an asymmetric key pair comprising a public key and a private key, of which the public key is known, and the method includes the additional steps of:
receiving from the recipient the condition and first key encrypted using the public key of the trusted party;
decrypting the condition and first key using the private key of the trusted party prior to comparing the evidence against the condition to confirm that the recipient does meet the condition.

19. A method according to claim 18 wherein it includes the additional steps of:
receiving from the recipient its public key;
encrypting the first key with the recipient's public key, and
transmitting the encrypted first key to the recipient.

20. A method according to claim 18 wherein the first key is an asymmetric key pair.

21. A method according to claim 17 wherein the trusted party is requested by the originator to generate an asymmetric key pair to act as the first key and once the asymmetric key pair has been generated the encrypting first key is provided to the originator, and the method includes the additional steps of:
receiving the condition from the originator;
storing the condition and the asymmetric first key pair;
upon receipt of the evidence from the recipient that they meet the condition, retrieving the condition and asymmetric first key pair from store before comparing the evidence against the condition to confirm that the recipient does meet the condition, and
providing to the recipient the decrypting key of the asymmetric first key pair to act as a decrypting first key.

22. A method according to claim 21 wherein it includes the additional step of encrypting the decrypting first key with the recipient's public key before transmitting it to the recipient.

23. A computer system for implementation of the method of claim 1.

24. A computer system for implementation of the method of claim 10.

25. A computer system for implementation of the method of claim 14.

26. A computer system for implementation of the method of claim 17.

27. A computer system for passing data securely from an originator to a recipient comprising a first computer entity associated with the originator, a second computer entity associated with the recipient and a third computer entity associated with a trusted party, there being communication means between the first computer entity and the second computer entity and between the second computer entity and the third computer entity,
the first computer entity selecting a condition to be met by the recipient before receipt of the data and a first key generated without reference to the condition, and encrypting the data with that first key, and encrypting the condition and the first key using a public key of the trusted party, and making both available to the second computer entity;
the second computer entity being arranged to forward evidence that the recipient meets the condition to the third computer entity, and
the third computer entity being arranged to compare the evidence with the condition and if satisfied that the recipient meets the condition to provide the first key to the second computer entity for decryption of the data.

28. A computer system according to claim 27 wherein the trusted party has a public key and:
the first computer entity is arranged to encrypt the condition and the first key using the trusted party's public key and make that available to the second computer entity,
the second computer entity is arranged to forward the encrypted condition and first key to the third computer entity, and
the third computer entity is arranged to decrypt the condition and first key before comparing the evidence with the condition.

29. A computer system according to claim 28 wherein:
the second computer entity is arranged to provide a public key of the recipient to the third computer entity, and
the third computer entity is arranged to encrypt the first key with the recipients public key before transmitting it to the recipient.

30. A computer system according to claim 27 wherein:
the first computer entity is arranged to provide the condition to the third computer entity,
the third computer entity is arranged to generate an asymmetric first key pair and to provide the encrypting first key to the first computer entity, and
the second computer entity is arranged to provide the third computer entity with the condition and the evidence.

31. A method of passing data securely from an originator to a recipient comprising the steps of:
the originator selecting a condition that the recipient must meet for decryption of the data;
the originator selecting a trusted party having a public key;
the originator selecting a first key without reference to the condition;
the originator encrypting the data using the first key;
the originator encrypting the condition and the first key using the public key of the trusted party;
the originator making the condition, and the encrypted data and the encrypted condition and first key, available to the recipient;
upon receipt by the trusted party of the recipient's public key, the encrypted condition and first key, and evidence that the recipient meets the condition, the trusted party decrypts the condition and first key, satisfies itself that the recipient meets the condition, provides the first key to the recipient, and
the recipient decrypts the data using the first key.

32. A method of passing data securely from an originator to a recipient comprising the steps of:
the originator selecting a condition that the recipient must meet for decryption of the data;
the originator selecting a trusted party;
the trusted party generating an asymmetric key pair without reference to the condition and providing the encrypting key of the asymmetric key pair to the originator to act as a first encrypting key;
the originator providing the condition to the trusted party;
the trusted party storing the condition and the asymmetric key pair;
the originator encrypting the data using the first encrypting key;
the originator making the condition, and the encrypted data available to the recipient;
upon receipt by the trusted party from the recipient of the evidence that the recipient meets the condition the trusted party retrieves the condition and asymmetric key pair from store, satisfies itself that the recipient meets the condition, and provides the decrypting key of the asymmetric key pair to the recipient to act as a first decrypting key, and
the recipient decrypting the data using the first decrypting key.
